(19) United States
(12) Patent Application Publication
(10) Pub. No.: US 2023/0089757 A1
(43) Pub. Date: Mar. 23, 2023

(54) CALL ROUTING BASED ON TECHNICAL SKILLS OF USERS

(71) Applicant: Hewlett-Packard Development Company, L.P., Spring, TX (US)

(72) Inventors: Shameed Sait M A, Bangalore (IN); Niranjan Damera Venkata, Chennai (IN); Raghavendra Gangahanumaiah, Bangalore (IN)

(21) Appl. No.: 17/795,450

(22) PCT Filed: Jan. 29, 2020
(86) PCT No.: PCT/US20/15639

§ 371 Date: Jul. 26, 2022

(51) Int. Cl. H04M 3/523; G10L 15/22; G10L 15/02; G06F 40/295; G10L 15/18; H04M 3/51

(52) U.S. Cl. CPC H04M 3/5232; G10L 15/22; G10L 15/02; G06F 40/295; G10L 15/1815; H04M 3/5166; G10L 2015/227

(57) ABSTRACT

Aspects of call routing based on technical skills of users are discussed. Responses to a set of questions posed to a user are received to assess a technical skill level of the user. The user may be categorized in a category from among a plurality of categories based on the technical skill level and a decision may be provided to a route a call from the user to one of a human agent and a virtual agent based on the categorization.

### BACKGROUND

Customers may contact customer support centers with a query, an issue, and the like, in relation to a product or service. The customer support centers may deploy human support agents and virtual support agents to interact with the customers to resolve their queries.

### BRIEF DESCRIPTION OF DRAWINGS

The following detailed description references the figures, wherein:

FIG. 1 illustrates a system for call routing based on technical skills of users, according to an example implementation of the present subject matter.

FIG. 2 illustrates a computing environment for call routing based on technical skills of users, according to an example implementation of the present subject matter.

FIG. 3 illustrates a workflow for categorizing users based on technical skills of users, according to an example implementation of the present subject matter.

FIG. 4 illustrates a workflow for categorizing users based on technical skills of users and technical complexity of a query, according to an example implementation of the present subject matter.

FIG. 5 illustrates a method of call routing based on technical skills of users, according to an example implementation of the present subject matter.

FIG. 6 illustrates a method of call routing based on technical skills of users and technical complexity of a query, according to an example implementation of the present subject matter; and

FIG. 7 illustrates a computing environment implementing a non-transitory computer-readable medium for call routing based on technical skills of a user and technical complexity of a query of the user, according to an example implementation of the present subject matter.

### DETAILED DESCRIPTION

A customer support center is generally a location where virtual support agents and human support agents answer telephone calls or respond to text messages from users seeking support. When a user contacts a customer support center, the first interaction may take place with a virtual support agent, hereinafter referred to as a virtual agent, or a human support agent, hereinafter referred to as a human agent.

A virtual agent may be a computer implemented application that serves as a virtual customer care agent and provides automated guidance to users. To provide the automated guidance, the virtual agent may employ various predefined rules or artificial intelligence based techniques or a combination thereof. A human agent may be a person who can converse with the customer and provide guidance to help the customer resolve their issues. The human agent may be able to discuss the issue in more detail with the customer than the virtual agent, better identify customer emotions, and may also be able to provide customized resolution steps. However, human agents may also need to be trained on various issue resolution processes for them to be effective. The efficiency of human agents may be lower in some cases, for example, when routine issues are to be resolved. Also, the cost of providing customer support by human agents may be higher.

In one scenario, a virtual agent may first provide a series of instructions in response to a query posed by the user. The user may execute the instructions to aid in diagnosis and resolution of the issue. In case the virtual agent is unable to resolve the issue, the call may be transferred to a human agent. However, some users may be more suited to receiving support from human support agents and may be dissatisfied in case the call is first handled by a virtual agent. On the other hand, some users may be able to easily resolve the issue with the support received from virtual agents. Providing support from human agents to such users may increase the cost of providing support services and reduce the efficiency of usage of virtual agents.

Aspects of the present subject matter relate to routing calls of users to virtual agents or human agents based on the technical skills of users. In the present subject matter, a technical skill level of the user is assessed to determine whether the user qualifies for use of the virtual agent.

In an example, when a user calls a customer support center to seek a resolution for product or service issues or for enquires, the user may be provided with a set of questions. In an example, an interactive voice response (IVR) may provide the set of questions to the user. In another example, a human agent may provide the set of questions. In yet another example, an automated conversation tool, such as a chatbot, may provide the set of questions. The user may provide responses to the set of questions. The responses may be used to detect the technical skill level of the user. In one example, the received responses may be used to categorize the user based on the technical skill level of the user.

Based on the responses, the user may be categorized, for example, into a first category or a second category. The users categorized in the first category may be those who have a higher technical skill level than average technical skills and the users categorized in the second category may be those who have an average technical skill level or a lower technical skill level than average. For example, if a user indicates that they have carried out or attempted to carry out some technical actions, such as rebooting the device or installing an application, they may be categorized in the first category. On the other hand, users who indicate that they are not familiar with technical terms, such as rebooting, or are unable to understand an error displayed on a computing device may be categorized in the second category.

In one example, a first machine learning model can be used to categorize the user from whom a call is received for technical support and, based on the category, the call may be routed to a human agent or a virtual agent. In one example, the call from a user categorized as belonging to the first category may be routed to the virtual agent as the user of the first category may have a higher technical skill level than average and may be able to resolve the query with the guidance received from the virtual agent. In another example, the call from a user categorized as belonging to the second category may be routed to a human agent to provide them more detailed guidance in view of their lower technical skill level.

In addition to the categorization of the user, an issue or an intent of a user query may also be determined and classified based on the complexity of the issue. A second machine learning model may be used to identify and classify the issue. In one example, the query may be classified as a complex query or a non-complex query based on the issue. Calls related to complex queries may be routed to the human agent. In one example, even if a user has a higher technical skill level than average, but the call is related to a complex query, the call may be routed to a human agent to provide support to the user. Thus, various decision rules may be used to route the calls based on the categorization of the user and classification of the query.

In some examples, there may be more than two categories of users and more than two classes of queries used for determining whether the call is to be directed to a virtual agent or a human agent based on the decision rules. For example, if the query is classified as being of intermediate complexity and the user is categorized as having an average technical skill level, the call may be transferred to a virtual agent. In another example, if the query is classified as being non-complex and the user is categorized as having a lower than average technical skill level, the call may be transferred to a human agent.

Thus, the present subject matter provides for improved user experience, reduces call volumes to be handled by human agents, increases query resolution efficiency, and reduces costs by routing user calls to virtual support agents or human support agents based on the technical skills of a user and the technical complexity of a query posed by the user.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

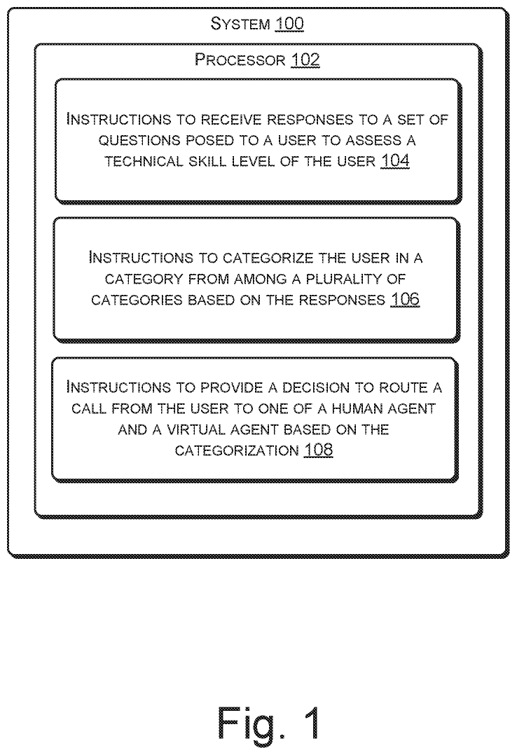

FIG. 1 illustrates a system 100 for call routing based on technical skills of users, according to an example implementation of the present subject matter. The system 100 may be implemented as any of a variety of systems, such as a desktop computer, a laptop computer, a server, a tablet device, and the like.

The system 100 includes a processor 102. The processor 102 may be implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions. The functions of the processor 102 may be provided through the use of dedicated hardware as well as hardware capable of executing machine readable instructions.

In addition to the processor 102, the system 100 may also include interface(s) and system data (not shown in FIG. 1). The interface(s) may include a variety of machine readable instructions-based interfaces and hardware interfaces that allow interaction with a user and with other communication and computing devices, such as network entities, web servers, networked computing devices, external repositories, and peripheral devices. The system data may serve as a repository for storing data that may be fetched, processed, received, or created by the processor 102.

In operation, the processor 102 may execute instructions 104 to receive responses to a set of questions posed to a user to assess a technical skill level of the user. In an example, a user may call a customer support center to seek a resolution to their query. The query may be related to, for example, products/services of interest, the working of a product, and the like. In response to the call, the user may be provided with a set of questions. In an example, an interactive voice response (IVR) may be initiated by the processor 102 to provide the set of questions to the user. In another example, a human agent may provide the set of questions. In yet another example, a chatbot may provide the set of questions. In various examples, the questions may be provided in audio format or as speech converted to text or in text.

In one example, the set of questions may be provided in a series, with a next question being provided based on the response received for a previous question. The user may provide responses to the set of questions as text or speech, which may be converted into text. The processor 102 may monitor the responses received from the user. The processor 102 may execute instructions 106 to categorize the user in a category from among a plurality of categories based on the responses. In one example, the plurality of categories may correspond to the technical skill level and the type of support to be provided to the user.

In an example, initially, the categorization of users into two or more categories may be done by human agents. A large set of categorized data may be gathered to train a first machine learning model. In one example, the first machine learning model may be trained to categorize a user based on a probability of the user being technically skilled as determined from the responses of the user. In one example, each category may be associated with a probability range of a user being technically skilled and the user may be classified into one of the categories based on the probability determined for the user.

For example, in case two categories are used for categorization of the user, the first category may be associated with a probability range of greater than 0.6 (i.e., >0.6 to 1) and the second category may be associated with a probability range of 0-0.6. In another example, in case four categories are used, the first category may be associated with a probability range of >0.8 to 1, the second category may be associated with a probability range of >0.6 to 0,8, the third category may be associated with a probability range of >0.3 to 0.6, and the fourth category may be associated with a probability range of 0 to 0.3. The various probability ranges may thus correspond to various technical skill level thresholds for categorization of the user.

The processor 102 may subsequently use the first machine learning model to categorize users based on their technical skill levels. In an example, the training of the first machine learning model may be performed by the same system as or a different system from the one that executes the first machine learning model.

Accordingly, the processor 102 may execute instructions 106 to categorize the user, for example, into a first category or a second category, using the first machine learning model. Users categorized in the first category may be those who have a higher than average technical skill level and users categorized in the second category may be those who have an average or lower than average technical skill level. While the description is provided based on the categorization of users into two categories, in other examples additional categories may also be used.

Further, the processor 102 may execute instructions 108 to provide a decision to route a call from the user to one of a human agent and a virtual agent based on the categorization. For example, the processor 102 may use decision rules to determine the decision to route the call. In an example, calls from users belonging in the first category may be routed to a virtual agent as a user of the first category may be expected to be able to resolve their query with the guidance received from the virtual agent. In another example, calls from users categorized as belonging in the second category may be routed to a human agent to provide them more detailed guidance in view of their lower technical skill level.

Thus, the call from a user may be routed to one of a virtual agent and a human agent based on the technical skills of the user for more efficient use of virtual and human agents. The human agent to whom the call is routed may be the same as or different from the human agent who provided the set of questions to the user initially.

In an example, when the call from the user seeking resolution for their query is routed to one of the human agent or the virtual agent as explained above, the human agent or the virtual agent may also consider the initial responses received from the user to provide resolution steps for resolution of the user query.

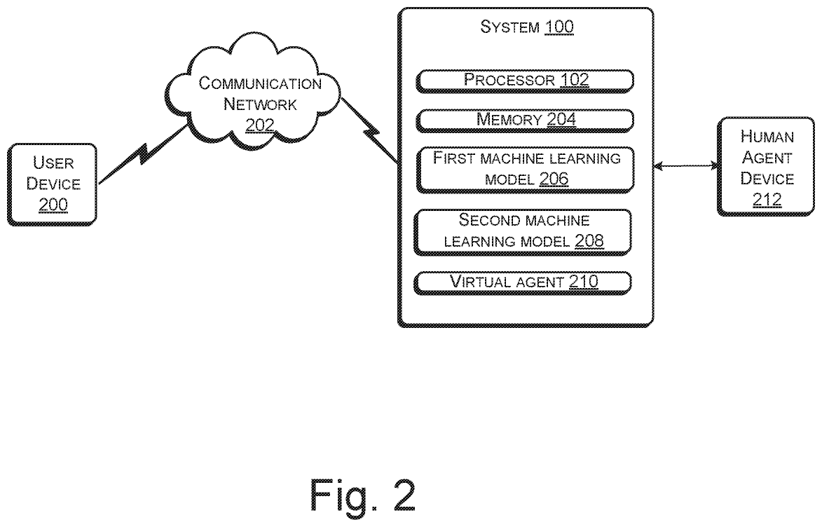

FIG. 2 illustrates a computing environment for call routing based on technical skills of users, according to an example implementation of the present subject matter. In the computing environment, the system 100 may be connected to a user device 200 through a communication network 202. In one example, the computing environment may be a cloud environment. The system 100 may thus be implemented in the cloud to provide various services to the user device 200.

The user device 200 may be, for example, a laptop, a personal computer, a tablet, a multi-function printer, a smart device, a mobile phone, a landline phone, and the like.

The communication network 202 may be a wireless or a wired network, or a combination thereof. The communication network 202 may be a collection of individual networks, interconnected with each other and functioning as a single large network (e.g., the Internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network includes various network entities, such as transceivers, gateways, and routers.

The system 100 may also include a memory 204 coupled to the processor 102. In an example, a first machine learning model 206, a second machine learning model 208, and other data, such as questions to be asked of users, query resolution steps, and the like may be stored in the memory 204 of the system 100. The memory 204 may include any non-transitory computer-readable medium including volatile memory (e.g., RAM), and/or non-volatile memory (e.g., EPROM, flash memory, Memristor, etc.). The memory 204 may also be an external memory unit, such as a flash drive, a compact disk drive, an external hard disk drive, a database, or the like.

The system 100 may receive a call from a user placed through the user device 200. The call may be, for example, a voice call, a text message, a chat message, or the like. For ease of discussion, communication of the system 100 with the user device 200 is described as communication of the system 100 with the user. The call received from the user may be related to a query about, for example, products/services of interest, the working of a product, and the like. The system 100 may provide a set of questions, for example, as a series of questions, to the user to assess a technical skill level of the user. In an example, an interactive voice response (IVR) or an automated conversation tool like a chatbot may be initiated by the processor 102 of the system 100 to provide the set of questions to the user. In another example, a human agent device 212 may be used by a human agent to provide the set of questions to the user. In an example, the human agent device 212 may be for example, a laptop, a mobile device, a tablet, a desktop computer, a landline phone, or the like. For ease of discussion, communication of the system 100 or the user device 200 with the human agent device 212 is described as communication of the system 100 or the user with the human agent.

In an example, the responses received from the user to the questions may be used to categorize the user based on their technical skill level using the first machine learning model 206 as discussed above. In one example, in addition to the technical skill level, an emotion of the user may be assessed and used for categorization of the user. For example, if a user is assessed as having a higher technical skill level than a predefined technical skill level threshold, but is assessed as being angry or in a hurry based on the responses, the user may be categorized in a next category that is of lower technical skill level so as to receive support from a human agent. For example, if based on the technical skill level, the user is identified as belonging to the first category, but due to the emotion being identified as angry, the user may be categorized in the second category.

In addition to the categorization based on technical skills, the processor 102 may analyze an issue or an intent of the user query and may classify the user query based on the technical complexity of the query. A second machine learning model 208 may be trained to identify and classify the technical complexity of the query. In an example, initially, the classification of queries may be performed by human agents. A large set of classified data may be gathered to train the second machine learning model 208. In one example, the second machine learning model may be trained to classify the query based on a probability of the query being technically complex as determined from the query and the responses of the user. In one example, each class may be associated with a probability range of a query being complex and the query may be classified into one of the classes based on the probability determined for the query.

For example, in case two classes are used for classification, a first class may be associated with a probability range of greater than 0.8 (i.e., >0.8 to 1) and a second class may be associated with a probability range of 0-0.8. In another example, in case three classes are used, the first class may be associated with a probability range of >0.8 to 1, the second class may be associated with a probability range of >0.4 to 0.8, and the third class may be associated with a probability range of 0 to 0.4. The various probability ranges may thus correspond to various technical complexity thresholds for classification of the query. The training of the second machine learning model 208 may be performed by the same system as or a different system from the one that executes the second machine learning model 208.

In one example, the query may be classified as a complex query (belonging to a first class) or a non-complex query (belonging to a second class), While the description is provided based on two classes into which the query may be classified, in other examples additional classes may also be used.

In an example, when the user query and the responses to the set of questions are received from the user, the processor 102 of the system 100 may utilize the first machine learning model 206 and the second machine learning model 208 to determine the technical skill level of the user and the technical complexity of the query. Further, the processor 102 may decide to route the call to one of a human agent and a virtual agent 210 based on the technical skill level of the user and the technical complexity of the query.

To decide on routing of the call, the processor 102 may use various decision rules applied to the determined user category and query class. For example, if the user is categorized into the second category, the call may be routed to a human agent for both complex and non-complex queries. In another example, if the query is complex, the call may be routed to a human agent for both first and second category of users. In another example, where the user is categorized as belonging to a third category (probability of being technically skilled being>0.3-0.6) and the query is classified as being of the third class (probability of being complex being 0-0.4), the call may be routed to a virtual agent. In yet another example, where the user is categorized as belonging to a third category (probability of being technically skilled being>0,3-0,6) and the query is classified as being of the second class (probability of being complex being 0.4-0.8), the call may be routed to a human agent. In other examples, other decision rules may be defined for use by the processor 102, based on the number of categories in which users are categorized and number of classes in which queries are classified, in order to efficiently provide customer support services.

In one example, the decision rules may be defined manually based on the experience of human agents in dealing with various categories of users and complexities of queries. In one example, at the end of a call, a human agent or the user may provide a feedback to the system 100 to indicate if the call may have been handled by a virtual agent or to indicate whether any problems arose during the call, for better categorization of users, classification of queries, and decision making. The feedback may be used to update the decision rules and the machine learning models.

In an example, the routing of the call may be performed by the system 100 based on the decision determined by the processor 102. In another example, the system 100 may provide the decision of routing the call to an external computing device connected to the system 100 and the external computing device may perform the call routing to the virtual agent or the human agent. In one example, after the call is routed, the human agent or virtual agent to whom the call is routed may also use the responses of the user to determine and provide the resolution steps to the user. In one example, on routing the call, the query of the user, the set of questions provided to the user, and responses received may also be made available to the agent to whom the call is routed. The agent may also seek further information regarding the issue while providing the resolution steps to efficiently resolve the issue.

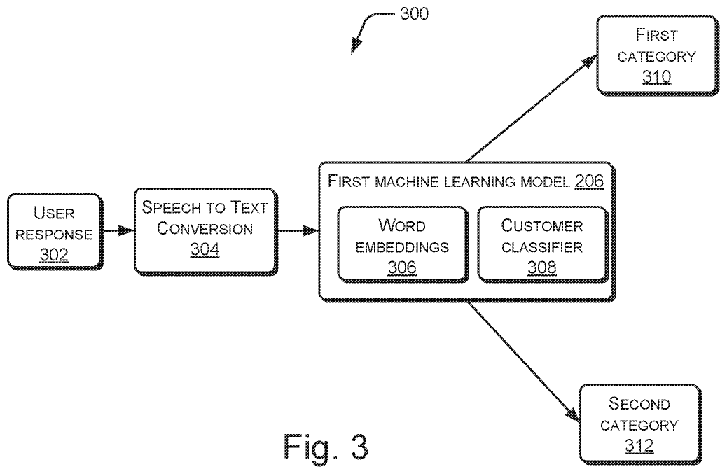

FIG. 3 illustrates a workflow 300 for categorizing users based on technical skills of users, according to an example implementation of the present subject matter. The workflow 300 may be implemented by the system 100. In an example, when a user calls the customer support center, a series of questions may be provided to the user to assess a technical skill level of the for example, by an interactive voice response (IVR), a chatbot, or a human agent.

In an example, the user may provide responses 302 to the set of questions in the form of speech or text. The responses received in the form of speech may get transcribed into text using a speech to text conversion 304. The responses received from the user may be provided to the first machine learning model 206 to categorize the user into a category from among a plurality of categories of technical skill.

To categorize the user into a category, the responses received from the user may be converted into feature vectors from a vector space using word embedding representations, also referred to a word embeddings 306. The vector space used may be specific to a troubleshooting domain in one example. The word embeddings 306 may be numerical representations of words that capture the semantic relationship between the words. In an example, the numeric representation would be such that words with similar meanings, for example, ‘restart’ and ‘reboot’, may have a similar numeric representation.

In one example, word vectors of the extracted features are positioned in the vector space such that words that share common contexts are located in close proximity to one another in the space. The distance from the words in the vector space may be measured to identify the nearest word representative of the word used in the response. For example, for the word ‘customer’, the vector space may provide multiple results that may have a similar meaning to the original word ‘customer’. Further, the distance from the word ‘customer’ from the list of words in the vector space may be identified. For example, the word ‘CU’ and ‘Cust’ may have the least distance to the word ‘customer’. Accordingly, the word embeddings 306 may be used to find the words that have same context as the words that may have been used for training the first machine learning model for categorizing the users.

In an example, the word “okay” may be the response provided by a user for a question posed to the user, such as “have you performed troubleshooting before?”. In an example, other responses such as “yes” and “of course” may have a similar context as the word “okay”. The vector space may list multiple such words with a similar context to the word “okay” and position them close to each other in the vector space. In one example, the distance of the word “okay” from “yes” may be identified and may be used by the first machine learning model 206 for determining a probability that the user has a high level of technical skills.

In an example, a customer classifier 308 may be used to categorize the user based on the vectors obtained from the word embeddings 306. In one example; a support vector machine (SVM) classifier may be used as the customer classifier 308. In other examples, other classifiers may be used.

In an example, the user may be categorized into a first category 310 or a second category 312 by the customer classifier 308. In one example, each category may be associated with a predefined skill level threshold or probability range of the user being technically skilled. For example, the users categorized under the first category 310 may be those who may receive support from a virtual agent due to them having a higher technical skill level than the predefined technical skill level threshold and the users categorized under the second category 312 may be those who may receive support from a human agent due to them having a lower technical skill level than the predefined technical skill level threshold. While the description is provided based on two categories of user; in other examples additional categories may also be used as discussed above.

In an example scenario; the user may call the customer support center regarding an issue such as a printer related issue. A respondent, such as an interactive voice response (IVR) or a chatbot or a human agent, may provide a set of questions related to the printer issue. The set of questions may be provided in series, such as ‘what troubleshooting steps have you performed?’, ‘were any software driver or firmware changes made on the printer?’, and the like. The user may provide responses to the set of questions. In an example, the responses from the user may be analyzed by the first machine learning model 206 using word embeddings 306 and the customer classifier 308 to assess the technical skill level of the user. In one example, if the customer classifier 308 determines that the word embeddings of the responses provided by the user include technical terms or denote actions taken by the user that indicate a high level of technical skills, the customer classifier 308 may categorize the user into the first category 310. If the customer classifier 308 determines that the word embeddings are not technical in nature, the customer classifier 308 may categorize the user in the second category 312.

In another example, in addition to the technical skill level, emotions of the user may be used for categorization of the user. In an example, emotions may be also identified from the call based on the words used in the responses using the word embeddings 306. In another example, voice analysis for variations in voice tone may also be used to identify emotions, such as anger, and may be provided to the customer classifier 308 in addition to the word embeddings 306. In one example, the customer classifier 308 may categorize users identified as being angry or in a hurry into a lower category of technical skill level than that determined from the responses of the user.

Based on the categorization, the calls may be routed to a human agent or a virtual agent based on decision rules. In an example, the calls from users categorized under the first category 310 may be routed to a virtual agent, as the user of first category 310 may have higher technical skill level than the predefined technical skill level threshold and may be expected to be able to resolve the query with the guidance received from the virtual agent. In another example, the calls from users categorized under the second category 312 may be routed to the human agent to provide them more detailed guidance in view of their lower technical skills or emotional state. In an example, when the call from the user seeking resolution for their query is routed to one of the human agent or the virtual agent, the human agent or the virtual agent may also utilize the responses provided by the user to the series of questions to provide resolution steps for resolution of the user query. For example, if the user had indicated in one of the responses that they have recently installed an update to a printer driver, the agent may take this into account while providing the resolution steps.

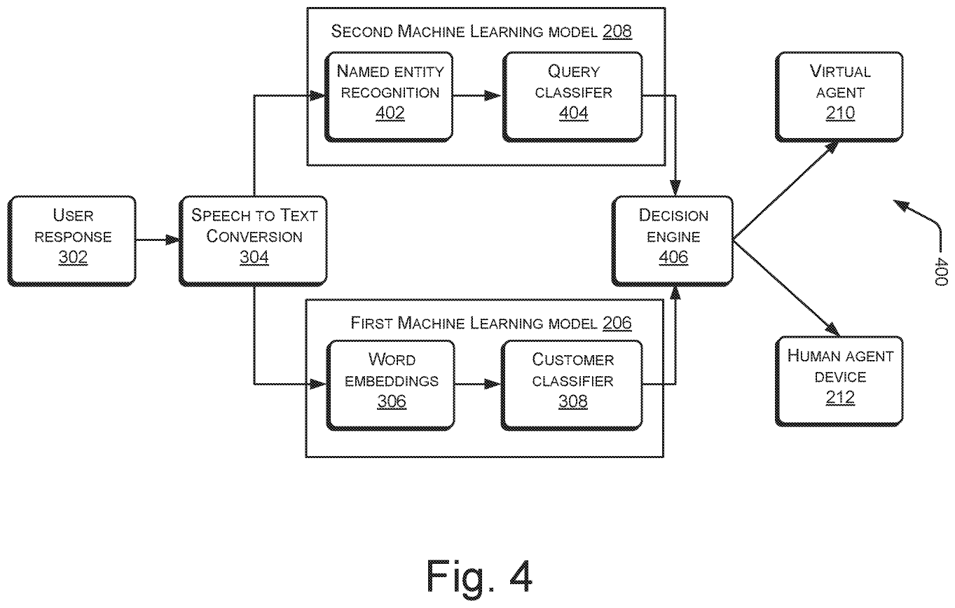

FIG. 4 illustrates a workflow 400 for categorizing users based on technical skills of users and technical complexity of a query, according to an example implementation of the present subject matter. The workflow 400 may be implemented by the system 100. As discussed with reference to FIG. 3, responses 302 to a series of questions may be received, for example, through an IVR, from a user seeking resolution to a query, speech to text conversion 304 may be performed where applicable, and the responses may be analyzed by the first machine learning model 206 to categorize the user. Categorization of users based on technical skills may be performed by the first machine learning model 206 using word embeddings 306 and customer classifier 308 as explained previously.

Additionally, the query may be classified based on the technical complexity using the second machine learning model 208. In an example, initially, the classification of queries may be performed by human agents. A large set of classified data may be gathered and used to train the second machine learning model 208.

To classify the query, the responses provided by the user may be converted into features using named entity recognition 402. Named entity recognition 402 helps to locate and classify named entities mentioned in unstructured text responses received from the user. For example, it helps in identifying specific words, such as printer, driver, paper, and the like, in the query and responses received from the user. In an example, the user may state ‘printer is not working’ in the form of unstructured text. Further, in response to a question, the user may mention that ‘paper is jammed’. Thus, named entity recognition 402 may recognize the words printer and paper from the query and responses.

Based on the named entity recognition 402, a query classifier 404 may predict the issue the user is calling about and classify the query into a class denoting complexity of the query. In an example, the issues for which the resolution steps are expected to be complicated may be classified as complex issues, for example, print quality issues in a printer. In an example, the issues which can be solved by the customers by following a sequence of resolution steps, without human agent guidance, are classified as non-complex issues, for example, removing paper jammed in a printer. In one example, each class may be associated with a predefined complexity level threshold or probability range of the query being technically complex. In an example, a classifier such as support vector machines (SVM) may be used as the query classifier 404. In other examples, other classifiers may be used. Thus, the query classifier 404 may analyze pieces of text recognized from user query and responses and may classify the issue of the query, for example, as complex or non-complex.

In an example, a decision engine 406 may receive the user categorization based on technical skill level and query classification based on technical complexity from the first machine learning model 206 and the second machine learning model 208, respectively. The decision engine 406 may decide to route the call to one of a virtual agent 210 and a human agent device 212 of a human agent based on the technical skill level and the technical complexity. In an example, the decision engine 406 may use decision rules to determine to whom the call is to be routed. The agent to whom the call is routed may be the same as or different from the agent who provided the series of questions initially in response to the user query.

In one example, if the user is categorized into a first category and the query from the user is non-complex, the calls from the user may be routed to the virtual agent 210, as the user of the first category may be able to resolve their issues based on resolution steps provided by the virtual agent 210. In another example, if the user is categorized into a second category and the query from the user is non-complex, the calls from the user may be routed to the human agent device 212, as the user of the second category may not be technically skilled enough to troubleshoot issues with guidance from the virtual agent 210. In another example, if the query from the user is complex, then the call may be routed to a human agent for both the first and second category of users.

In various examples, the decision rules used by the decision engine 406 may be predefined initially and updated based on feedback received from human agents and users after a call is concluded.

Further, when the call from the user seeking resolution for their query is routed to one of the human agent or the virtual agent, the human agent or the virtual agent may also utilize the responses provided by the user to provide guidance for resolution of the user query.

Thus, the overall costs of providing customer support may be reduced and efficiency of providing support and user satisfaction may be increased.

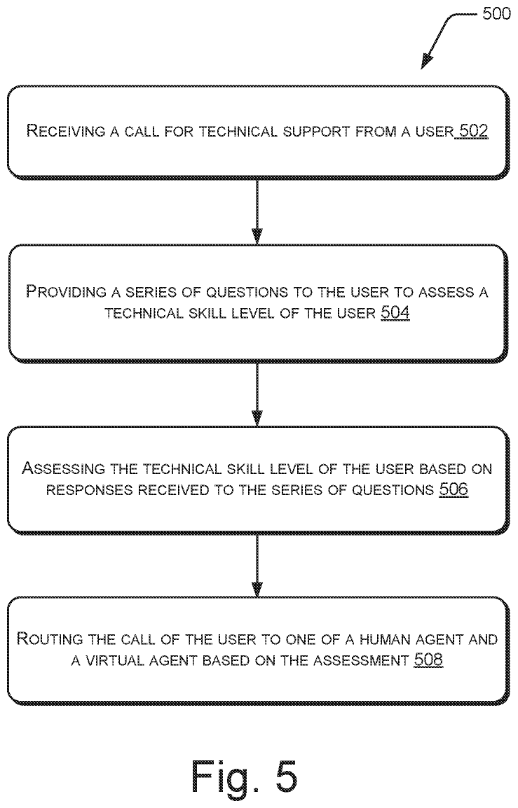

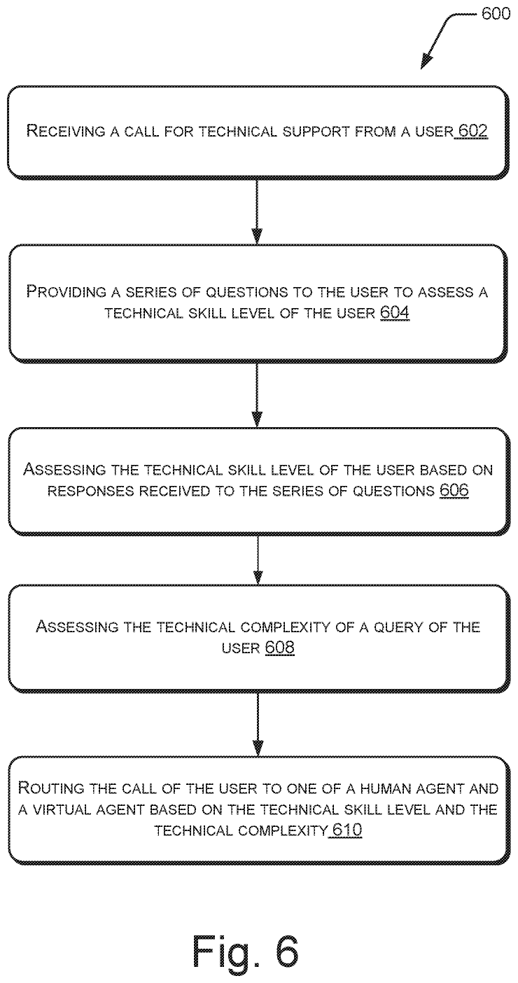

FIG. 5 and FIG. 6 illustrate methods 500 and 600 of call routing based on technical skills of users, according to example implementations of the present subject matter.

The order in which the methods 500 and 600 are described is not intended to be construed as a limitation, and some of the described method blocks can be combined in a different order to implement the methods or alternative methods. Furthermore, the method 500 and 600 may be implemented in any suitable hardware, computer-readable instructions, or combination thereof. The blocks of the methods 500 and 600 may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer-readable and encode computer-executable instructions, where the instructions perform some or all of the blocks of the methods 500 and 600. While the methods 500 and 600 may be implemented in any device, the following description is provided in the context of system 100 as described earlier with reference to FIGS. 1 and 2 and workflows 300 and 400 implemented by the system 100 as described earlier with reference to FIGS. 3 and 4 for ease of discussion.

Referring to method 500, at block 502, a call for technical support is received from a user of a user device. The user device may be, for example, the user device 200. In an example, the user may call for technical support for resolving queries about products/services of interest, working of a product, and the like. The call may be in any format, such as a voice call, a text message, or a chat message.

At block 504, a series of questions may be provided to the user to assess a technical skill level of the user. The series of questions may be provided by a respondent. In an example, an interactive voice response (IVR) may be used as the respondent to provide the series of questions to the user. In another example, a human agent may be the respondent and may provide the series of questions through a human agent device 212. The user may respond to the series of questions.

At block 506, the technical skill level of the user may be assessed based on the responses received to the series of questions. In an example, a first machine learning model, such as the first machine learning model 206 may be used to categorize the user, for example into a first category or a second category based on the technical skill level. In an example, a word embedding representation of the responses may be generated, features may be extracted from the word embeddings, and the user may be categorized based on the features. In one example, in addition to the technical skill level, an emotional state of the user may be taken into account for performing the categorization.

At block 508, the call of the user may be routed to one of a human agent and a virtual agent based on the assessment. In an example, the call may be routed to the virtual agent when the user is categorized in the first category as having a technical skill level above an average technical skill level usable to resolve the query. In an example, the call may be routed to the human agent when the user is categorized in the second category as having a technical skill level below the average technical skill level usable to resolve the query.

FIG. 6 illustrates a method 600 of call routing based on technical skills of users and technical complexity of a query, according to an example implementation of the present subject matter. The blocks 602-606 may correspond to the blocks 502-506 discussed above with reference to FIG. 5.

Referring to method 600, at block 602, a call for technical support is received from a user of a user device. The user device may be, for example, the user device 200. In an example, the user may call for seeking assistance from the customer support center for resolving a query. In an example, the query is related to products/services of interest, working of a product, and the like.

At block 604, a series of questions may be provided to the user to assess the technical skill of the user. In an example, an interactive voice response (IVR) may be used to provide the set of questions to the user. In another example, a human agent may provide the set of questions through a human agent device 212.

At block 606, the technical skill level of the user may be assessed based on responses received from the user. In an example, the first machine learning model 206 may be used to categorize the user into a category from among a plurality of categories based on a technical skill level of the user being assessed as being greater than a predefined threshold technical skill level corresponding to that category. In addition, an emotional state of the sure may be sued to categorize the user.

In addition to the technical skill of the user, at block 608, technical complexity of the query of the user may be assessed. In an example, a second machine learning model, such as the second machine learning model 208, may be used to classify the issue or query based on its technical complexity. In an example, the query may be classified into a class from among a plurality of classes based on a technical complexity of the query. For example, the query may be classified into a first class when the technical complexity of the query is assessed as being greater than a predefined threshold technical complexity. In one example, named entity recognition may be applied to the query and the responses to identify features and the query may be classified based on the features.

In an example, at block 610, the call of the user may be routed to one of a human agent and a virtual agent based on the technical skill level of the user and the technical complexity of the query. In an example, the virtual agent may be the virtual agent 210. In an example, a decision engine, such as the decision engine 406, may provide a decision to route the call to the human agent or the virtual agent based on decision rules.

In one example scenario, if the user is categorized under a first category (high technical skill level) and the query from the user is non-complex, the calls from the user may be routed to the virtual agent, as the user of the first category may be able to resolve the query from resolution steps provided by the virtual agent. In another example scenario, if the user is categorized under a second category (low technical skill level) and the query from the user is non-complex, the calls from the user may be routed to the human agent, as the user of the second category may not be technically skilled to troubleshoot issues with guidance from the virtual agent 210. In another example scenario, if the user is categorized in either the first category or the second category and the query from the user is complex, calls from the user may be routed to the human agent, to receive guidance from the human agent.

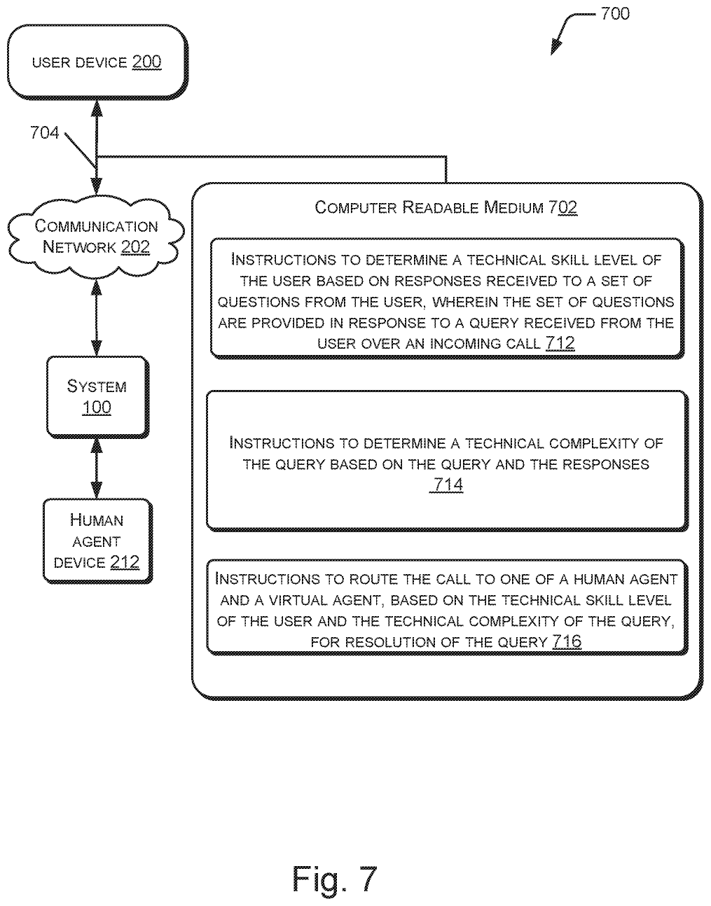

FIG. 7 illustrates a computing environment 700, implementing a non-transitory computer-readable medium for call routing based on a technical skill level of a user, according to an example implementation of the present subject matter.

In an example, the non-transitory computer-readable medium 702 may be utilized by a system, such as the system 100. The computing environment 700 includes a user device, such as the user device 200, and the system 100 communicatively coupled to the non-transitory computer-readable medium 702 through a communication link 704. The non-transitory computer-readable medium 702 may be, for example, an internal memory device or an external memory device. In some examples, the non-transitory computer-readable medium 702 may be a part of the memory 204.

In an example implementation, the computer-readable medium 702 includes a set of computer-readable instructions, which can be accessed by the processor 102 of the system 100 and executed to route a call based on a technical skill level of a user and the technical complexity of a query of the user.

In one implementation, the communication link 704 may be a direct communication link, such as any memory read/write interface. In another implementation, the communication link 704 may be an indirect communication link, such as a network interface. In such a case, the user device 200 may access the non-transitory computer-readable medium 702 through a communication network 202. The communication network 202 may be a single network or a combination of multiple networks and may use a variety of different communication protocols.

Referring to FIG. 7, in an example, the non-transitory computer-readable medium 702 includes instructions 712 that cause the processor 102 of the system 100 to determine a technical skill level of the user based on responses received to a set of questions from the user, in response to a query received from the user over an incoming call. In an example, the query may be related to, for example, a query about products/services of interest, a query about the working of a product, and the like. In an example, in response to the call, the user may be provided with a set of questions. In an example, an interactive voice response (IVR) may be initiated by the processor 102 to provide the set of questions to the user. In another example, a human agent may provide the set of questions. In an example, to determine the technical skill level of the user, the user may be categorized into a category from among a plurality of categories based on the responses. In an example, the processor 102 may use the first machine learning model 206 to categorize the user based on the technical skill level of the user. The first machine learning model 206 may have been trained based on categorization of users performed by human agents. The first machine learning model 206 may use word embedding representations to determine features from the responses of the user for categorization of the user.

The non-transitory computer-readable medium 702 includes instructions 714 that cause the processor 102 of the system 100 to determine the technical complexity of the query. In an example, a second machine learning model 208 may be used to identify and classify the technical complexity of the query. In one example, the query may be classified in a class from among a plurality of classes based on the query and responses. The second machine learning model 208 may have been trained based on classification of queries and responses performed by human agents. The second machine learning model 208 may use named entity recognition to determine features from the responses of the user for classification of the query.

The non-transitory computer-readable medium 702 includes instructions 716 that cause the processor 102 of the system 100 to route the call to one of a human agent and a virtual agent based on the technical skill level of the user and the technical complexity of the query, for resolution of the query. In an example, a decision engine 406 may be used to decide to route the call to the human agent or the virtual agent. In an example, the decision engine may use decision rules related to the technical skill level of the user and the technical complexity of the query for routing the call to the human agent or the virtual agent as has been explained earlier. In an example, when the call from the user seeking resolution for their query is routed to one of the human agent or the virtual agent as explained above, the human agent or the virtual agent may provide resolution steps corresponding to the user query for resolution of the user query. To provide the resolution steps, the agent may also take into account the responses provided by the user to the set of questions.

The present subject matter thus provides an improved user experience by routing user calls to virtual support agents or human support agents based on the technical skills of the user. The present subject matter also reduces call volumes to be handled by human agents, increases query resolution efficiency, and reduces costs by efficiently routing user calls to virtual support agents or human support agents.

The preceding description has been presented to illustrate and describe examples of the principles described. This description is not intended to be exhaustive. Many modifications and variations are possible in light of the above teaching.

1. A system comprising:
a processor to:
receive responses to a set of questions posed to a user to assess a technical skill level of the user;
categorize the user in a category from among a plurality of categories based on the technical skill level of the user; and
provide a decision to route a call from the user to one of a human agent and a virtual agent based on the categorization.

2. The system of claim 1, wherein the set of questions is posed by one of an interactive voice response (IVR) and the human agent.

3. The system of claim 1, wherein the user is categorized into one of a first category and a second category; wherein the first category is indicative of a higher technical skill level than a predefined technical skill level threshold and the second category is indicative of a lower technical skill level than the predefined technical skill level threshold.

4. The system of claim 3, wherein the processor is to decide to route the call to the virtual agent if the user is categorized into the first category and to the human agent if the user is categorized into the second category.

5. The system of claim 1, wherein the processor is to:
classify a query of the user based on technical complexity of the query; and
provide a decision to route the call from the user to one of the human agent and the virtual agent based on the technical skill level of the user and the technical complexity of the query.

6. The system of claim 5, wherein the processor is to decide to route the call to the human agent if the query has higher complexity that a predefined technical complexity threshold or if the user has a lower technical skill level than a predefined technical skill level threshold.

7. A method comprising:
receiving a call for technical support from a user;
providing a series of questions to the user to assess a technical skill level of the user;
assessing the technical skill level of the user based on responses received to the series of questions; and
routing the call of the user to one of a human agent and a virtual agent based on the assessment.

8. The method of claim 7, wherein assessing the technical skill level of the user comprises:
generating a word embedding representation of the responses;
extracting features from the word embeddings; and
categorizing the user based on the features.

9. The method of claim 7 comprising routing the call of the user to the virtual agent when the user is assessed as having a higher than average technical skill level and routing the call of the user to the human agent when the user is assessed as having an average or lower than average technical skill level.

10. The method of claim 7 comprising:
assessing a technical complexity of a query of the user; and
routing the call of the user to one of a human agent and a virtual agent based on the assessments of the technical skill level and the technical complexity.

11. The method of claim 10, wherein assessing the technical complexity comprises:
applying named entity recognition to the query and the responses to identify features of the query and the responses; and
classifying the query based on the features.

12. A non-transitory computer-readable medium comprising instructions for routing calls from users, the instructions being executable by a processor to:
determine a technical skill level of the user based on responses received to a set of questions from the user, wherein the set of questions are provided in response to a query received from the user over an incoming call;
determine a technical complexity of the query based on the query and the responses; and
route the call to one of a human agent and a virtual agent, based on the technical skill level of the user and the technical complexity of the query, for resolution of the query.

13. The non-transitory computer-readable medium of claim 12, wherein the instructions are executable to determine the technical skill level of the user based on feature extraction from a word embedding representation of the responses.

14. The non-transitory computer-readable medium of claim 12, wherein the instructions are executable to determine the technical complexity of the query based on feature extraction from a named entity recognition applied to the query and the responses.

15. The non-transitory computer-readable medium of claim 12, wherein the instructions are executable to apply decision rules based on the determined technical skill level and technical complexity to decide whether the call is to be routed to the human agent or the virtual agent.
